(19) United States
(12) Patent Application Publication
(10) Pub. No.: US 2011/0125571 A1
(43) Pub. Date: May 26, 2011

(54) METHOD AND SYSTEM FOR SPEED EFFICIENT AND RELEVANCY EFFICIENT ADVERTISING THROUGH A WEB ENABLED ELEMENT

(75) Inventor: Sunil JAGADISH, Bangalore (IN)

(73) Assignee: Yahoo! Inc., Sunnyvale, CA (US)

(21) Appl. No.: 12/623,457

(22) Filed: Nov. 23, 2009

(51) Int. Cl. G06Q 30/00; G06F 17/30

(52) U.S. Cl. 705/14.43; 705/14.54; 705/14.73; 707/736; 707/748; 707/E17.014

(57) ABSTRACT

An example of a method comprises receiving a search query initiated by the user and transmitted from the user terminal to the server and identifying, by using server software that communicates with the user terminal, an area of interest in the interface. The method also comprises identifying a context based on at least one of the area of interest and the search query. The method further comprises obtaining, by using server software that communicates with the user terminal. Furthermore, the method comprises extracting, based on the one or more browser parameters and a plurality of predetermined preferences and also extracting advertisements from the database based on the set of rules and the context. The method comprises communicating the advertisements to the user terminal and rendering the advertisements on a display based on the context, the one or more browser parameters and the set of rules. Other embodiments disclose a system.

### BACKGROUND

As internet became popular among a plurality of users, service providers started to capture the user's attention by displaying attractive advertisements in a web browser. Typically, the web browser is an interface for a user with a computer system and is used for adding, retrieving and transferring information. The plurality of websites in the web browser is configured to connect the advertisements with monetization links, whereby a maximum value can be extracted from the advertisement. A rank of a web page is dependent on average time spent on each position of the webpage.

In existing advertising techniques, for example, advertising phrases are displayed as a part of the web browser's text window to the plurality of users. The advertisements are placed on the small spaces in the web browsers, and are displayed to the plurality of users as small clickable images. When the user clicks on one of the images, the user is connected to the advertiser's own commercial web server. The user then navigates through the web page in the web browser, for example if the user clicks on the image or a phrase ‘gifts’ in the web page, an updated URL would be“http://shopping.yahoo.com/search;_ylt=AoT0ikOmEcpAw4cxNVcKveYEgFoB?p=gi fts&did=”. The updated URL includes cryptic data. However, in the existing techniques the URL may be meaningless to the user. Some techniques exist to reduce the length of the URL or to convert a long URL to a short URL. However, the techniques may not draw the user's attention for viewing the URL.

In the existing techniques, a tool bar, an address bar, a status bar and a search bar may not be used for capturing user attention. In light of foregoing discussion there is need of a technique for acquiring and holding the user's attention to view the web URL.

### SUMMARY

Embodiments of the present disclosure described herein provide a method, a system, and an article of manufacture for speed efficient and relevancy efficient advertising through a web enabled element.

An example of a method of the present disclosure of displaying advertising copy to a user of a computer system, the computer system including a user terminal having a graphical display, a browser including a graphical user interface, and an advertisement rendering unit present within a browser that causes the interface to be displayed on the graphical display, a database containing a plurality of advertisements, and a server in electrical communication with the user terminal and the database, the method comprises receiving a search query initiated by the user and transmitted from the user terminal to the server and identifying, by using server software that communicates with the user terminal, an area of interest in the interface. The method also comprises identifying a context based on at least one of the area of interest and the search query. The method further comprises obtaining, by using server software that communicates with the user terminal. A one or more browser parameters comprise at least one of a screen width of the area of interest, a screen height of the area of interest, and a bit size of the area of interest. Furthermore, the method comprises extracting based on the one or more browser parameters and a plurality of predetermined preferences for enabling the area of interest to be maximally visible and distinguishable. A set of rules comprising at least one of an advertising category, a date and a time of usage of the browser, a bit size of the area of interest, a time period for each advertisement display, a plurality of graphic effects applied for each advertisement, time for refreshing the area of interest, and a number of advertisements per area of interest. The method also comprises extracting advertisements from the database based on the set of rules and the context and communicating the advertisements and the set of rules to the user terminal. Moreover, the method comprises rendering the advertisements on the display based on the context, the one or more browser parameters and the set of rules while enhancing visibility and distinction variables of the area of interest.

An example of an article of manufacture of displaying advertising copy to a user of a computer system, the computer system including a user terminal having a graphical display, a browser including a graphical user interface, and an advertisement rendering unit present within a browser that causes the interface to be displayed on the display, a database containing a plurality of advertisements, and a server in electrical communication with the user terminal and the database, the article of manufacture comprises a machine-readable medium. The machine-readable medium carries instructions operable to cause a programmable processor to receive a search query initiated by the user and transmitted from the user terminal to the server and to identify, by using server software that communicates with the user terminal, an area of interest in the interface. The machine-readable medium also identifies a context based on at least one of the area of interest and the search query. Further, the machine readable medium obtains, by using server software that communicates with the user terminal. A one or more browser parameters comprise at least one of a screen width of the area of interest, a screen height of the area of interest, and a bit size of the area of interest. Furthermore, the machine readable medium extracts based on the one or more browser parameters and a plurality of predetermined preferences for enabling the area of interest to be maximally visible and distinguishable. A set of rules comprising at least one of an advertising category, a date and a time of usage of the browser, a bit size of the area of interest, a time period for each advertisement display, a plurality of graphic effects applied for each advertisement, time for refreshing the area of interest, and a number of advertisements per area of interest. The machine readable medium also extracts advertisements from the database based on the set of rules and the context and communicates the advertisements and the set of rules to the user terminal Moreover, the machine readable medium renders the advertisements on the display based on the context, the one or more browser parameters and the set of rules while enhancing visibility and distinction variables of the area of interest.

An example of a system comprises a server. The server comprises a processor responsive to the instructions to receive a search query initiated by the user and transmitted from a user terminal to the server, to identify by using server software that communicates with the user terminal, an area of interest in the interface, to identify a context based on at least one of the area of interest and the search query, to obtain, by using server software that communicates with the user terminal, to extract based on the one or more browser parameters and a plurality of predetermined preferences for enabling the area of interest to be maximally visible and distinguishable, and to extract advertisements based on the set of rules and the context. The server further comprises a communication medium for communicating the advertisements and the set of rules with the user terminal. The system also comprises an advertisement rendering unit present within a browser that renders the advertisements on the display based on the context, the one or more browser parameters and the set of rules while enhancing visibility and distinction variables of the area of interest. The server also comprises a rule analyzer unit to execute the set of rules. The server further comprises a cache controller unit to optimize caching of advertisements by one of more electronic devices. Moreover, the server also comprises a database to store and provide advertisements to the processor.

### BRIEF DESCRIPTION OF THE FIGURES

FIG. 1 illustrates a block diagram of an environment in accordance with one embodiment;

FIG. 2 illustrates a block diagram of a server, in accordance with one embodiment;

FIG. 3 illustrates a block diagram of an electronic device, in accordance with one embodiment; and

FIG. 4 shows a flowchart illustrating a method for displaying advertisements through a web enabled element, in accordance with one embodiment.

### DETAILED DESCRIPTION OF THE EMBODIMENTS

In accordance with a first aspect, a method of displaying advertising copy to a user of a computer system, the computer system including a user terminal having a graphical display, a browser including a graphical user interface, and an advertisement rendering unit present within a browser that causes the interface to be displayed on the graphical display, a database containing a plurality of advertisements, and a server in electrical communication with the user terminal and the database, the method including receiving a search query initiated by the user and transmitted from the user terminal to the server, identifying, by using server software that communicates with the user terminal, an area of interest in the interface, identifying a context based on at least one of the area of interest and the search query, obtaining, by using server software that communicates with the user terminal, one or more browser parameters comprising at least one of a screen width of the area of interest, a screen height of the area of interest, and a bit size of the area of interest, extracting, based on the one or more browser parameters and a plurality of predetermined preferences for enabling the area of interest to be maximally visible and distinguishable, a set of rules comprising at least one of: an advertising category, a date and a time of usage of the browser, a bit size of the area of interest, a time period for each advertisement display, a plurality of graphic effects applied for each advertisement, time for refreshing the area of interest and a number of advertisements per area of interest, extracting advertisements from the database based on the set of rules and the context, communicating the advertisements and the set of rules to the user terminal, and rendering the advertisements on the graphical display based on the context, the one or more browser parameters and the set of rules while enhancing visibility and distinction variables of the area of interest.

In accordance with the first aspect, the advertisement is one of a hyperlinked advertisement and a web-linked advertisement. The step of obtaining is based on computing a function of a fraction of the screen width based on a heuristic mechanism. The step of extracting the advertisements comprises ranking the advertisements based on a testing mechanism. The step of communicating the advertisements further comprises the advertisements resulting in improved caching mechanism based on the set of rules and the one or more browser parameters. The step of rendering is based on the ranking. The advertisements are one of a text based advertisement, a picture based advertisement, a video based advertisement, and a combination thereof. The step of communicating the advertisements is based on saved cookies and saved browsing history. The step of communicating the advertisements further comprises refreshing the area of interest of the graphical user interface based on one of: a pre-defined time period and a manual refresh of a webpage.

In accordance with a second aspect, an article of manufacture of displaying advertising copy to a user of a computer system, the computer system including a user terminal having a graphical display, a browser including a graphical user interface, and a an advertisement rendering unit present within a browser that causes the interface to be displayed on the graphical display, a database containing a plurality of advertisements, and a server in electrical communication with the user terminal and the database, the article of manufacture comprising a machine readable medium and instructions carried by the machine-readable medium and operable to cause a programmable processor to perform receiving a search query initiated by the user and transmitted from the user terminal to the server, identifying, by using server software that communicates with the user terminal, an area of interest in the interface, identifying a context based on at least one of the area of interest and the search query, obtaining, by using server software that communicates with the user terminal, one or more browser parameters comprising at least one of: a screen width of the area of interest, a screen height of the area of interest, and a bit size of the area of interest, extracting, based on the one or more browser parameters and a plurality of predetermined preferences for enabling the area of interest to be maximally visible and distinguishable, a set of rules comprising at least one of an advertising category, a date and a time of usage of the browser, a bit size of the area of interest, a time period for each advertisement display, a plurality of graphic effects applied for each advertisement, time for refreshing the area of interest and a number of advertisements per area of interest, extracting advertisements from the database based on the set of rules and the context, communicating the advertisements and the set of rules to the user terminal, and rendering the advertisements on the graphical display based on the context, the one or more browser parameters and the set of rules while enhancing visibility and distinction variables of the area of interest.

In accordance with the second aspect, the step of extracting the advertisements comprises ranking the advertisements based on a testing mechanism. The step of communicating the advertisements further comprises the advertisements resulting in improved caching mechanism based on the set of rules and the one or more browser parameters. The step of rendering is based on the ranking. The advertisements are one of a text based advertisement, a picture based advertisement, a video based advertisement, and a combination thereof. The step of communicating the advertisements is based on saved cookies and saved browsing history. The step of communicating the advertisements further comprises refreshing the area of interest of the graphical user interface based on one of: a pre-defined time period and a manual refresh of a webpage.

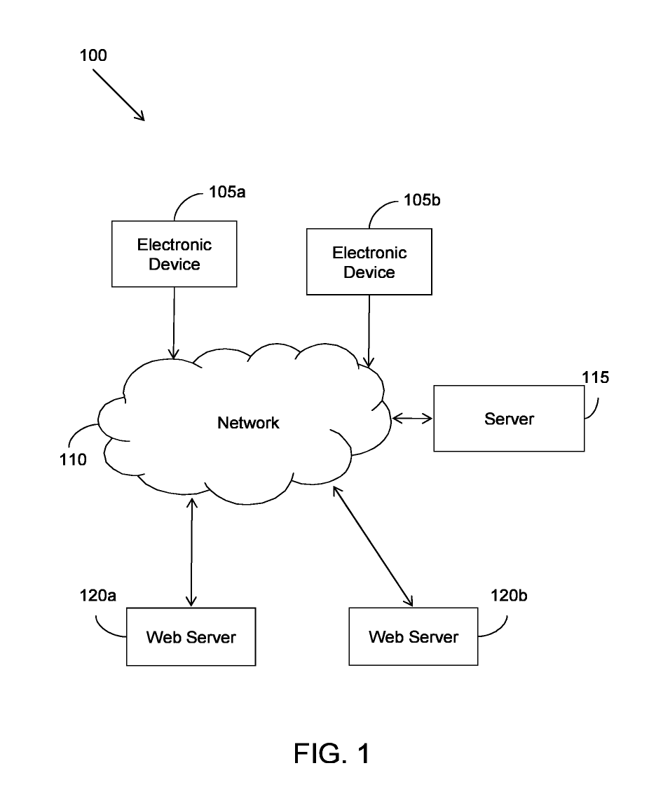

FIG. 1 is a block diagram of an environment 100, in accordance with various exemplary embodiments and their implementations. The environment 100 includes one or more electronic devices, for example, an electronic device 105a and an electronic device 105b connected to a server 115 through a network 110. The server in turn is connected to one or more web servers, for example, a web server 120a and a web server 120b.

The server 115 includes a database and a communication interface. The database is used for storing advertisements.

Examples of the electronic devices 105a and 105b include, but are not limited to, computers, mobile devices, laptops, palmtops, internet protocol televisions (IPTVs) and personal digital assistants (PDAs). Examples of the network 110 include, but are not limited to, a Local Area Network (LAN), a Wireless Local Area Network (WLAN), a Wide Area Network (WAN), wired network, wireless network, internet and a Small Area Network (SAN).

The server 115 receives a search query and an area of interest of the GUI is identified herein after referred as the area of interest, from one or more electronic devices 105a and 105b. Examples of the area of interest are a tool bar of a browser, a status bar of a browser, an address bar of a browser, an icon placed over a browser, a tab on the browser and a combination thereof. The search query may be one of a search keyword, a search key-string and content of a current webpage. Based on the search query, a context is identified by the server 115. Examples of the context are an inbox of a web based mailing webpage and a search engine navigation.

The server 115 also obtains browser parameters from the browser of the electronic devices 105a and 105b by using server software. The one or more browser parameters are at least one of a screen width of the area of interest, a screen height of the area of interest and a bit size of the area of interest. Based on the one or more browser parameters and a set of rules of the context the server 115 extracts advertisements from a database. The advertisements extracted are communicated to the browser of the electronic devices 105a and 105b. The advertisements are stored in the database and are one of a text based advertisement, a picture based advertisement, a video based advertisement and a combination thereof.

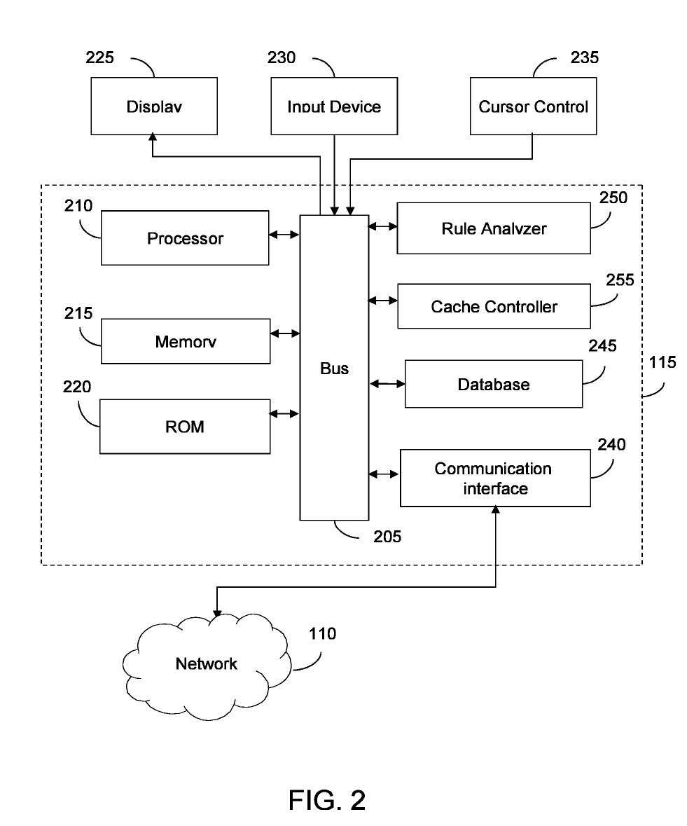

The advertisements are communicated to the electronic devices 105a and 105b based on the content provided by the web servers 120a and 120b. FIG. 2 illustrates a block diagram of a server 115, in accordance with one embodiment. The server 115 includes a bus 205 for communicating information, and a processor 210 coupled with the bus 205 for processing information. The server 115 also includes a memory 215, for example a random access memory (RAM) coupled to the bus 205 for storing instructions to be executed by the processor 210. The memory 215 can be used for storing temporary information required by the processor 210. The server 115 further includes a read only memory (ROM) 220 coupled to bus 205 for storing static information and instructions for the processor 210.

The server 115 can be coupled via the bus 205 to a display 225, for example a cathode ray tube (CRT) or liquid crystal display (LCD), for displaying information. An input device 230, including various keys, is coupled to the bus 205 for communicating information and command selections to the processor 210. In some embodiments, cursor control 235, for example a mouse, a trackball, a joystick, or cursor direction keys, for command selections to the processor 210 and for controlling cursor movement on the display 225 can also be present.

In one embodiment, the steps of the present disclosure are performed by the server 115 in response to the processor 210 executing instructions included in the memory 215. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The memory 215 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 210.

The server 115 also includes a communication interface 240 coupled to the bus 205 for enabling data communication. Examples of the communication interface 240 include, but are not limited to, an integrated services digital network (ISDN) card, a modem, a local area network (LAN) card, an infrared port, a Bluetooth port, a zigbee port, and a wireless port.

The server includes a database 245 and the advertisements communicated to the electronic devices 105a and 105b are stored in the database 245. In some embodiments, the processor 210 receives a search query initiated by the user and transmitted from a user terminal to the server, identifies an area of interest in the interface by using server software that communicates with the user terminal and identifies a context based on at least one of the area of interest and the search query. The processor further obtains one or more browser parameters, by using server software that communicates with the user terminal. The processor also extracts advertisements based on the one or more browser parameters and a plurality of predetermined preferences for enabling the area of interest to be maximally visible and distinguishable, and based on the set of rules and the context. The processor 210 also receives a set of rules from the rule analyzer 250. Based on the context, one or more browser parameters and the set of rules, the advertisements are communicated to the electronic devices 105a and 105b. A cache controller 255 of the server 115 optimizes the number of advertisements and the size of advertisements to be communicated to the electronic devices 105a and 105b.

In one embodiment, the database 245 is used for storing and extracting advertisements.

In another embodiment, the database 245 is a part of the server 115.

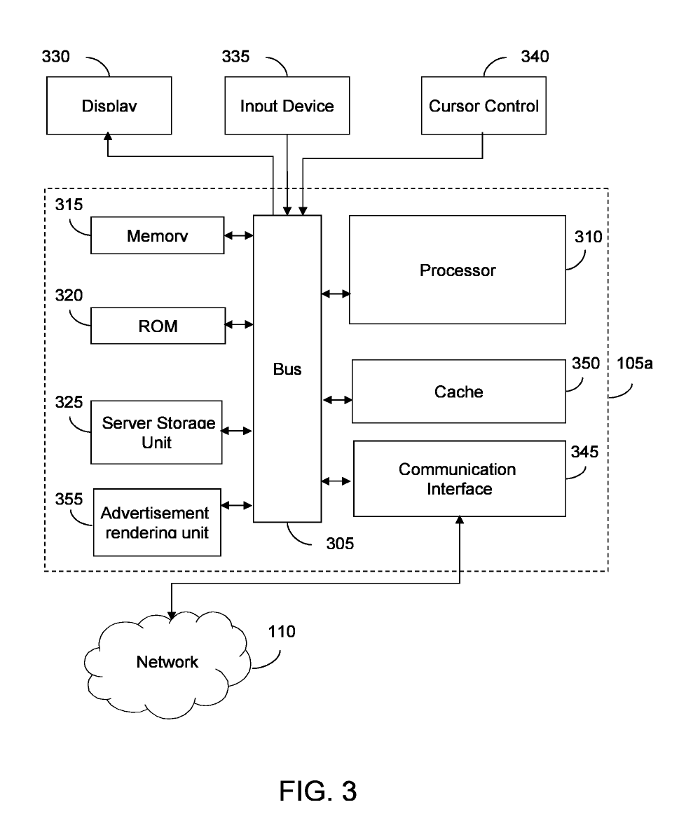

FIG. 3 illustrates a block diagram of an electronic device, in accordance with one embodiment. Consider the electronic device 105a. The electronic device 105a includes a bus 305 for communicating information, and a processor 310 coupled with the bus 305 for processing information. The electronic device 105a also includes a memory 315, for example a random access memory (RAM) coupled to the bus 305 for storing instructions to be executed by the processor 310. The memory 315 can be used for storing temporary information required by the processor 310. The electronic device 105a further includes a read only memory (ROM) 320 coupled to bus 305 for storing static information and instructions for the processor 310. A server storage unit 325, for example a magnetic disk, hard disk or optical disk, can be provided and coupled to bus 305 for storing information and instructions. The server storage unit 325 is used for storing the advertisements communicated by the server 115 to the electronic device 105a.

The electronic device 105a can be coupled via the bus 305 to a display 330, for example a cathode ray tube (CRT) or liquid crystal display (LCD), for displaying information. An input device 335, including various keys, is coupled to the bus 305 for communicating information and command selections to the processor 310. In some embodiments, cursor control 340, for example a mouse, a trackball, a joystick, or cursor direction keys, for command selections to the processor 310 and for controlling cursor movement on the display 330 can also be present.

In one embodiment, the steps of the present disclosure are performed by the electronic device 105a in response to the processor 310 executing instructions included in the memory 315. The instructions can be read into the memory 315 from a machine-readable medium, for example the server storage unit 325. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be a storage media. Storage media can include non-volatile media and volatile media. The server storage unit 325 can be a non-volatile media. The memory 315 can be a volatile media. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The machine readable medium can also include online links, download links, and installation links providing the instructions to be executed by the processor 310.

The electronic device 105a includes a communication interface 345 coupled to the bus 305 for enabling data communication. Examples of the communication interface 345 include, but are not limited to, an integrated services digital network (ISDN) card, a modem, a local area network (LAN) card, an infrared port, a Bluetooth port, a zigbee port, and a wireless port.

The electronic device 105a also includes a cache 350 coupled to the bus 305 for periodically refreshing the advertisements received from the server 115. The cache 350 is also used for refreshing the area of interest of the graphical user interface based on one of a pre-defined time period and a manual refresh of a webpage.

The electronic device 105a also includes an advertisement rendering unit 355 present within a browser for rendering the advertisements on the graphical display based on the context, the one or more browser parameters and the set of rules while enhancing visibility and distinction variables of the area of interest.

In some exemplary embodiments of the present disclosure, the processor 310 provides at least one of a browser parameter and a context of the current page in the browser to the server through the network 110. Based on at least one of the browser parameter, the context and a set of rules, advertisements are communicated to the processor 310 of the electronic device 105a.

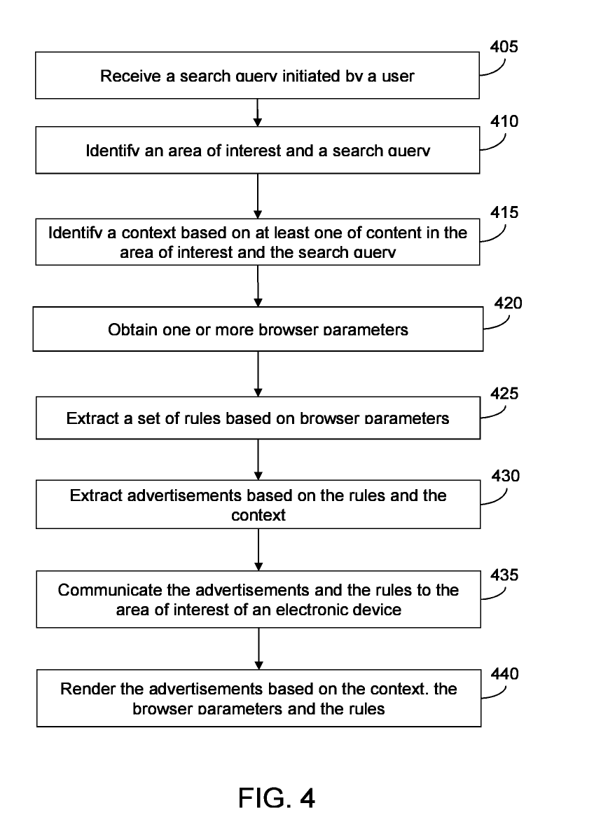

FIG. 4 shows a flowchart illustrating a method for displaying advertisements through a web enabled element, in accordance with one exemplary embodiment of the present disclosure. At step 405, a search query is received from a user. The search query initiated by the user is transmitted from a user terminal to the server. The user terminal is an electronic device.

At step 410, the server identifies an area of interest and a search query by using server software that communicates with the electronic device. Examples of the area of interest are a tool bar of a browser, a status bar of a browser, an address bar of a browser, an icon placed over a browser, a tab on the browser and a combination thereof. The search query, from the electronic device, is obtained from the content available in the current page of the browser. The advertisements communicated with the browser of the electronic device are categorized based on the search query.

In another embodiment, the search query is obtained from a keyword or a key-string provided by the user of the electronic device.

At step 415, a context is identified based on at least one of the area of interest and the search query. The context is based on the content of the current page of the browser. In one exemplary embodiment, if the user's current page is a search engine then, the context is identified and advertisements based on the keyword or the key-string is provided to the electronic device. In another embodiment, if the user's current page is an electronic mail (e-mail) webpage then, the context is identified based on the content of the e-mail operated by the user of the browser. In yet another embodiment, if the user's current page is a general web-page then, the context is identified based on the content in the web-page. The content of the current page includes a text or a multimedia content.

At step 420, one or more browser parameters are obtained. The one or more browser parameters are obtained by using the server software that communicates with the electronic device. The one or more browser parameters include at least one of a screen width of the area of interest, a screen height of the area of interest and a bit size of the area of interest. The one or more browser parameters are further obtained based on computing a function of a fraction of a screen width based on a heuristic mechanism. The one or more browser parameters are used by the processor of the server to selectively render the advertisement. For example, if the screen width of the area of interest is 50 mm, then the processor of the cache controller of the processor parses the width of the area of interest and identifies the possible advertisements to be place on the area of interest. The examples of the possible advertisements may be five advertisements of screen width 10 mm each or one advertisement of 20 mm and three advertisements of 10 mm each.

Similarly, another example is a screen height of the area of interest. According to a non-limiting example of the present disclosure, if the screen height is 5 mm and a text advertisement of height 2.5 mm each then, the cache controller selects two advertisements of height 2.5 mm each and provides the advertisements one below the other on the area of interest in the browser of the electronic device. The cache of the electronic device has a limited memory allocation. The cache controller controls the advertisements communicated to the cache of the electronic device by reducing the load on the cache of the electronic device.

If for example, the advertisement is text based, then a text summarization technique is used to reduce the number of words in the advertisement, without compromising on the context of the advertisement.

The caching mechanism of the electronic device is optimizing based on the set of rules and the one or more browser parameters.

At step 425, a set of rules are extracted. The set of rules include: at least one of an advertising category, a date and a time of the browser usage, a bit size of the area of interest, a time period for each advertisement display, a plurality of graphical effects applied for each advertisement, time for refreshing the area of interest, and number of advertisements per area of interest based on the one or more browser parameters and a plurality of predetermined preferences for enabling the area of interest to be maximally visible and distinguishable.

Example mechanism for refreshing the area of interest is an asynchronous JavaScript and extensible markup language (AJAX) based mechanism. During refreshing process a new advertisement is retrieved from the server asynchronously by web-based applications.

The rule analyzer of the server stores the set of rules. In one embodiment, the rules are predefined. In another embodiment, the set of rules are defined by an administrator of the server. In yet another embodiment, the set of rules are defined by a user of the electronic device.

For example, the user of the electronic device is viewing an e-mail inbox on the browser at 12.00 PM. The e-mail content includes the different toppings of a pizza. The cache controller identifies the context to be an e-mail context. The rule analyzer is defined with rules to identify the time and date of the browser usage and a time period for each advertisement. The time period for each advertisement is two minutes. Based on the rules and the context, an advertisement with a special meal offer at a nearest pizza parlor is provided to the user on the area of interest of the browser. The advertisement is refreshed by the browser automatically after the expiry of two minutes.

In some embodiments, the user may manually refresh the webpage. In another embodiment, the user may manually refresh the area of interest. The advertisement will be changed based on the refresh.

At step 430, the advertisements are extracted from a database. The method of extracting the advertisements is based on the set of rules and the context. The advertisements are stacked at the cache of the electronic device. The advertisements are ranked based on a testing mechanism. Examples of a testing mechanism are a bucket test and a regression test. The bucket test includes recording behavior of the users by providing advertisements of intuitive sizes and predefined sizes, and recording the number of clicks on the advertisements. The regression test includes gathering data regarding screen width, screen height, advertisement text, advertisement category, advertisers and, date and time. The gathered data is analyzed by the server to determine an apt advertisement.

At step 435, the server communicates the extracted advertisements and the set of rules to the cache of the electronic device. The advertisements are communicated based on the allotted memory in the cache of the electronic device. If, the cache has more memory to store advertisements then, a larger number of advertisements or an advertisement with larger bit size is communicated. The method reduced the risk caused due to the overloading of the cache of the electronic device.

In one exemplary embodiment of the present disclosure, the advertisements are communicated to the electronic device based on the saved cookies and saved browser history.

At step 440, the advertisements are rendered on the display based on the context, the one or more browser parameters and the set of rules while enhancing visibility and distinction variables of the area of interest. The browser present in the electronic device includes the advertisement rendering unit for rendering the advertisements on the graphical display, whereby a content of the advertisement is configured to suit appropriate display unit. For example, consider a text advertisement is to be rendered in the area of interest. A rule is defined to scroll the text from right end of the area of interest to the left end of the area of interest. The rule further includes the speed at which the text scrolls. Based on the rule, the text is rendered by scrolling the text from right end of the area of interest to the left end of the area of interest.

In one embodiment, the advertisements are hyperlinked and web-linked. The user may click on such hyperlink or the web-link to connect to a computer machine or a server. The advertisements may be linked to the home page of the advertisement provider.

In another embodiment, a small icon is provided on the browser of the electronic device. The icon is used to link the advertisement to a remote server or a remote computer.

Consider an example of a uniform resource locator (URL): http://in.search.yahoo.com/search?ei=utf-8&fr=yfp-t-in&type=ds&p=gifts. Here ‘http://in.search.yahoo.com’ is used to identify the domain of the webpage. The section ‘search?ei=utf-8&fr=yfp-t-in&type=ds&p=gifts’ is cryptic data is not of any use to the user of the electronic device. The search keyword is “Gifts”. The cryptic data is replaced by advertisements related to gifts, for example, http://in.search.yahoo.com/flowers bouquet and chocolates. Here “flowers bouquet and chocolates” is an advertisement hyperlinked to a website with gifting services. If the URL is selected to be copied, the advertisement is replaced with the cryptic data.

The advertisements and the number of advertisements are automatically adjusted based on the resizing of the browser window.

In some embodiments, the advertisements are displayed to the user of the electronic device attractively by one of a highlighting, a flashing effect, usage of bright colors and an eye catching font.

The present disclosure illustrates an improved method, a system and an article of manufacture for speed efficient and relevancy efficient advertising through a web enabled element. Exemplary advantages of the present disclosure include providing useful advertisements in the uniform resource locator (URL) of the browser. The browser will render most relevant advertisements based on the context. The advertisements are attractively rendered resulting in more traffic on the advertiser's webpage. The visitors of the webpage spend more time duration in the webpage by automatically refreshing the advertisements. The advertisements may be rendered in different area of interest. For example, an advertisement related to food may be displayed in a URL bar and another advertisement related to gifts may be displayed in a tool bar. The method disclosed includes refreshing the advertisements resulting in improved caching mechanism of the electronic device by selectively providing the advertisements to be stacked in the cache.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method of displaying advertising copy to a user of a computer system, the computer system including a user terminal having a graphical display, a browser including a graphical user interface, and an advertisement rendering unit present within the browser that causes the interface to be displayed on the display; a database containing a plurality of advertisements; and a server in electrical communication with the user terminal and the database, the method comprising:
receiving a search query initiated by the user and transmitted from the user terminal to the server;
identifying, by using server software that communicates with the user terminal, an area of interest in the interface;
identifying a context based on at least one of the area of interest and the search query;
obtaining, by using server software that communicates with the user terminal, one or more browser parameters comprising at least one of:
a screen width of the area of interest;
a screen height of the area of interest; and
a bit size of the area of interest;
extracting, based on the browser parameters and a plurality of predetermined preferences for enabling the area of interest to be maximally visible and distinguishable, a set of rules comprising at least one of:
an advertising category;
a date and a time of usage of the browser;
a bit size of the area of interest;
a time period for each advertisement display;
a plurality of graphic effects applied for each advertisement;
time for refreshing the area of interest; and
a number of advertisements per area of interest;
extracting advertisements from the database based on the set of rules and the context;
communicating the advertisements and the set of rules to the user terminal; and
rendering the advertisements on the graphical display based on the context, the browser parameters and the set of rules while enhancing visibility and distinction variables of the area of interest.

2. The method of claim 1, wherein the advertisements is one of a hyperlinked advertisement and a web-linked advertisement.

3. The method of claim 1, wherein the step of obtaining is based on computing a function of a fraction of the screen width based on a heuristic mechanism.

4. The method of claim 1, wherein the step of extracting the advertisements comprises ranking the advertisements based on a testing mechanism.

5. The method of claim 1, wherein the step of communicating the advertisements further comprises refreshing the advertisements resulting in improved caching mechanism based on the set of rules and the browser parameters.

6. The method of claim 1, wherein the step of rendering is based on the ranking.

7. The method of claim 1, wherein the advertisements are one of: a text based advertisement, a picture based advertisement, a video based advertisement, and a combination thereof.

8. The method of claim 1 wherein the step of communicating the advertisements is based on saved cookies and saved browsing history.

9. The method of claim 1, wherein the step of communicating the advertisements further comprises refreshing the area of interest of the graphical user interface based on one of: a pre-defined time period and a manual refresh of a webpage.

10. An article of manufacture of displaying advertising copy to a user of a computer system, the computer system including a user terminal having a graphical display, a browser including a graphical user interface, and an advertisement rendering unit present within the browser that causes the interface to be displayed on the graphical display; a database containing a plurality of advertisements; and a server in electrical communication with the user terminal and the database, the article of manufacture comprising:
a machine readable medium; and
instructions carried by the machine-readable medium and operable to cause a programmable processor to perform:
receiving a search query initiated by the user and transmitted from the user terminal to the server;
identifying, by using server software that communicates with the user terminal, an area of interest in the interface;
identifying a context based on at least one of the area of interest and the search query;
obtaining, by using server software that communicates with the user terminal, one or more browser parameters comprising at least one of:
a screen width of the area of interest;
a screen height of the area of interest; and
a bit size of the area of interest;
extracting, based on the browser parameters and a plurality of predetermined preferences for enabling the area of interest to be maximally visible and distinguishable, a set of rules comprising at least one of:
an advertising category;
a date and a time of usage of the browser;
a bit size of the area of interest;
a time period for each advertisement display;
a plurality of graphic effects applied for each advertisement;
time for refreshing the area of interest; and
a number of advertisements per area of interest;
extracting advertisements from the database based on the set of rules and the context;
communicating the advertisements and the set of rules to the user terminal; and
rendering the advertisements on the graphical display based on the context, the browser parameters and the set of rules while enhancing visibility and distinction variables of the area of interest.

11. The article of manufacture of claim 10, wherein extracting the advertisements comprises, ranking the advertisements based on a testing mechanism.

12. The article of manufacture of claim 10, wherein communicating the advertisements further comprises, optimizing the caching mechanism based on the set of rules and the browser parameters.

13. The article of manufacture of claim 10, wherein the rendering is based on the ranking.

14. The article of manufacture of claim 10, wherein the advertisements are one of a text based advertisement, a picture based advertisement, a video based advertisement, and a combination thereof.

15. The article of manufacture as claimed in claim 10, wherein communicating the advertisements is based on saved cookies and saved browsing history.

16. The article of manufacture of claim 10, wherein communicating the advertisements further comprises, refreshing the area of interest of the graphical user interface based on one of a pre-defined time period and a manual refresh of a webpage.

17. A system for displaying advertising copy comprising:
a server, the server comprising:
a processor responsive to the instructions to:
receive a search query initiated by the user and transmitted from a user terminal to the server;
identify, by using server software that communicates with the user terminal, an area of interest in the interface;
identify a context based on at least one of the area of interest and the search query;
obtain, by using server software that communicates with the user terminal, one or more browser parameters comprising at least one of:
a screen width of the area of interest;
a screen height of the area of interest; and
a bit size of the area of interest;
extract, based on the browser parameters and a plurality of predetermined preferences for enabling the area of interest to be maximally visible and distinguishable, a set of rules comprising at least one of:
an advertising category;
a date and a time of usage of the browser;
a bit size of the area of interest;
a time period for each advertisement display;
a plurality of graphic effects applied for each advertisement;
time for refreshing the area of interest; and
a number of advertisements per area of interest;
extract advertisements based on the set of rules and the context;
a communication interface for communicating the advertisements and the set of rules with the user terminal; and
a database to store and provide advertisements to the processor;
an advertisement rendering unit present within a browser that renders the advertisements on the graphical display based on the context, the browser parameters and the set of rules while enhancing visibility and distinction variables of the area of interest.

18. The server of claim 17 further comprising:
a rule analyzer unit to apply the set of rules; and
a cache controller unit to optimize caching of advertisements by one or more electronic devices.

19. The server of claim 18, wherein the rule analyzer and the cache controller unit optimize the advertisements to the electronic devices.

20. The server of claim 17, wherein the electronic device is in communication with the server through a network.
